(19) United States
(12) Patent Application Publication
(10) Pub. No.: US 2004/0129341 A1
(43) Pub. Date: Jul. 8, 2004

(54) Font

(75) Inventors: Iain Wallace Anderson, Staffordshire (GB); Peter Thomas Foster, Staffordshire (GB); Stuart William Molzahn, Derbyshire (GB); Stephen Paul Smith, Derbyshire (GB); Wendy Gladys Box, Stapenhill (GB); Rachel Joanna Galt, Staffordshire (GB); David Edwin Quain, Staffordshire (GB); Robert Alan Wright, Derbyshire (GB)

Correspondence Address: BAKER & BOTTS, 30 ROCKEFELLER PLAZA, NEW YORK, NY, 10112

(73) Assignee: Coors Worldwide Inc., Golden, CO

(21) Appl. No.: 10/337,038

(22) Filed: Jan. 6, 2003

(51) Int. Cl. B67C 3/34; B67C 3/26

(52) U.S. Cl. 141/268

(57) ABSTRACT

A font 2 to be mounted on a counter of a drinks bar to dispense draught beverage has a cantilever shaped body 6 with two ascending legs 8 which are either side of a through opening 4 and rise from a base 16 to an overhanging head 9 provided with a beverage dispenser nozzle 10 through which the beverage issues upon operation of lever 12. The base 16 has a rotatably driven platform 14 on which a drinking glass 20 stands to be filled. The font can have various lights to illuminate the glass which can be seen by a customer looking in direction. A through the opening 4 from a side of the font remote from the platform 14.

### FIELD OF THE INVENTION

This invention relates to a font for dispensing draught beverage. It is particularly applicable to fonts for dispensing draught alcoholic beverages such as beer or cider, but can also be used in fonts for dispensing non-alcoholic drinks.

### BACKGROUND TO THE INVENTION

Fonts for dispensing beverages, usually at a drinks bar, are very common. However they are generally functional in nature being arranged to dispense the beverage and carry some form of identification of the beverage. However, in order to attract customers to purchase beverage it is desirable to make the font attractive and interesting to potential customers.

### SUMMARY OF THE INVENTION

According to a first aspect of the invention a font arranged to be mounted on a drinks bar counter to dispense draught beverage comprises a base, a support arm extending upwards from the base and a head supported over the base by the support arm and including a dispensing nozzle for dispensing the beverage, the support arm and nozzle defining a dispense space in which a drinking vessel can be placed to receive beverage from the nozzle, wherein the support arm has a window through which a drinking vessel positioned in the dispense space can be viewed by a customer.

Preferably the support arm has an aperture therethrough which forms the window. Preferably the support arm is positioned to one side of the dispense space, and the dispense space has a further side opposite to said one side which further side is open to allow the drinking vessel to be placed in and removed from the location. Preferably the head is unsupported except for the support arm. Preferably the arm is curved so that it arches over the dispense space. Preferably the base includes a support arranged to support a drinking vessel in the dispense space. Preferably the support is arranged to rotate the drinking vessel. For example the support may comprise a rotatable platform.

Preferably the font further comprises drive means arrange to rotate the platform, most preferably during dispense of the beverage.

The present invention further provides a font arranged to be mounted on a drinks bar counter to dispense draught beverage, the font comprising a base, a support structure extending upwards from the base and a head supported over the base by the support structure and including a dispensing nozzle for dispensing the beverage, the support structure and nozzle defining a dispense space in which a drinking vessel can be placed to receive beverage from the nozzle, wherein the support structure is a cantilever structure positioned to one side of the dispense space and has a window through which a drinking vessel positioned in the dispense space can be viewed by a customer.

Preferably the support structure comprises a pair of legs defining an aperture therebetween which forms the window.

The present invention still further provides a font arranged to be mounted on a drinks bar counter to dispense draught beverage, the font comprising a base, a pair of support legs extending upwards from the base and a head supported over the base by the support legs and including a dispensing nozzle for dispensing the beverage, the support legs and nozzle defining a dispense space in which a drinking vessel can be placed to receive beverage from the nozzle, wherein the support legs are both positioned to one side of the dispense space and define a window therebetween through which a drinking vessel positioned in the dispense space can be viewed by a customer.

Preferably the font further comprises transparent material arranged to at least partially form said window. The font may further comprise at least one light source. Preferably said at least one light source is arranged to direct light into said dispense space so that it will strike a drinking vessel placed in the dispense space. Preferably the base includes a support arranged to support a drinking vessel in the dispense space, the support having at least one aperture therethrough, and said at least one light is arranged to direct light through said at least one aperture.

Desirably the transparent material is arranged to magnify at least a part of the vessel as seen by the customer. Alternatively the transparent material may be arranged to distort at least a part of the vessel as seen by the customer.

The transparent material may comprise an optical filter arranged to affect the colour of the vessel as seen by the customer. Preferably the optical filter is controllable so as to vary its filter characteristics. Alternatively the transparent material is replaceable so as to vary the optical characteristics of the transparent material on the font. Preferably the transparent material carries at least one of an image and a message. Preferably said at least one of an image and a message is variable. Preferably the font is arranged to dispense the beverage in a dispense cycle and said at least one of an image and a message is controlled so as to be varied at a predetermined point in the dispense cycle.

The font may further comprise a light source arranged to produce at least one of an image and a message on the vessel. The light source may be arranged to provide a pattern of light beams to produce said at least one of an image and a message. Alternatively the light source is arranged to produce light of a wavelength that will reveal said at least one of an image and a message on the vessel. For example the wavelength may be an ultra violet wavelength.

The dispensed beverage may be non-alcoholic or alcoholic, for example a beer, lager, ale, stout or porter, or cider.

Attention is drawn to two International patent applications, namely International Patent Application No. PCT/GB99/03824 (published under No. WO01/36582) and International Patent Application No. PCT/GB99/01551 (published under No. WO 99/60092). Any individual feature or any combination of such features of any beverage disclosed in either of those International applications, and any method or apparatus or part of any method or apparatus disclosed in either of those International Applications may be utilised in the dispense of beverage using a font which is the subject of this current application.

The invention will now be further described by way of example with reference to the accompanying drawing.

### BRIEF DESCRIPTION OF THE DRAWINGS

FIG. 1 is a perspective view of a font according to the invention.

### DETAILED DESCRIPTION OF THE PREFERRED EMBODIMENTS

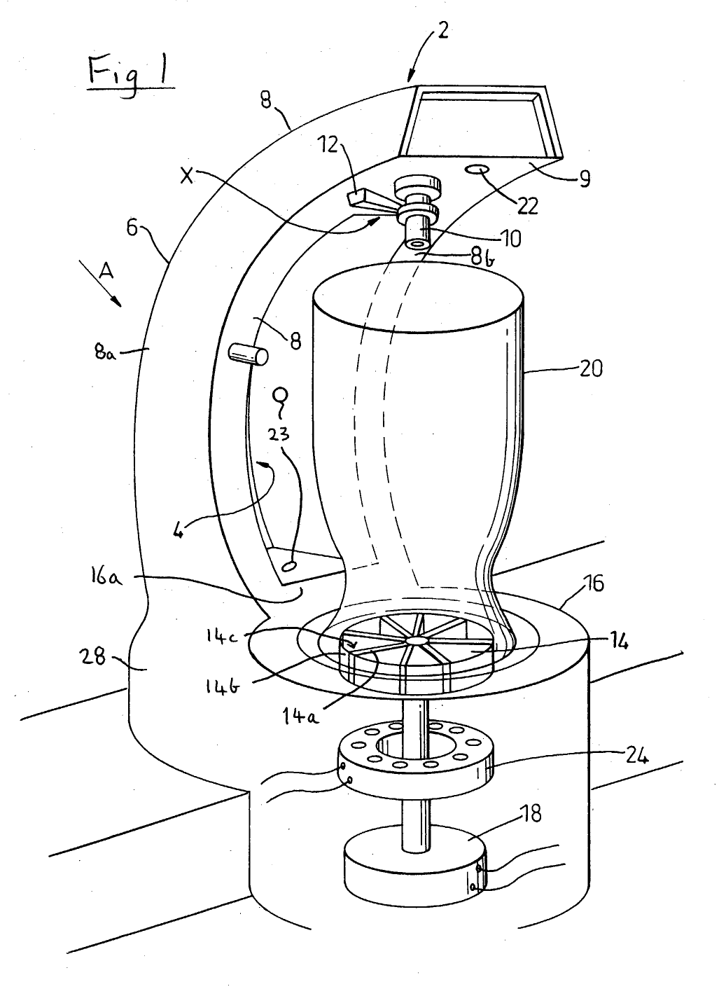

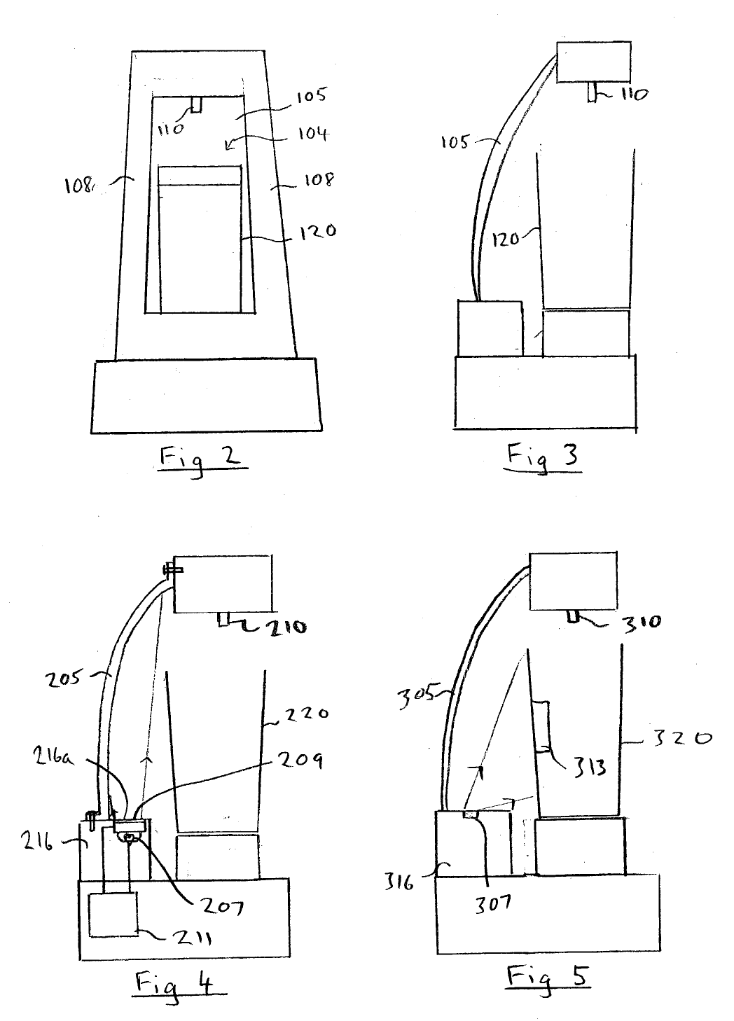

Referring to FIG. 1, a font comprises a body 6 having a base 16, a support arm 8 formed from two parallel ascending legs 8a, 8b extending upwards from one side of the base 16 and defining therebetween an opening 4. At the upper end of the support arm 8, the upper ends of the legs 8a, 8b meet and are joined to a head 9 which defines the upper edge of the opening 4 and supports a beverage dispenser nozzle 10 with an operating lever 12. The legs 8 are curved, being substantially vertical at their lower ends, so that they arch over the base 16 in cantilever fashion, forming a support structure for the head 9, which is supported over the base 16 with the nozzle 10 pointing downwards.

The base 16 has a round rotatable platform 14 within it which can be driven by an electric motor 18, for example a stepper motor. The platform 14 is level and is arranged to support a glass 20 beneath the nozzle 10 so that it can be filled with beverage. It is made up of a number of radial blades 14a and a circumferential ring 14b which between them define a number of apertures 14c through the platform 14.

The head 9 of the font is provided with a downwardly directed light source 22 in the form of a spot-light.

The opening 4 is illuminated or adorned by further light sources, for example light emitting diodes (LEDs) 23, which are mounted on the font around the opening 4, on the part 16a of the base 16 which defines the lower edge of the opening, the sides 8a of the legs 8 which define the sides of the opening, or the side region X of the head 9 which defines the upper end of the opening 4. These LEDs are therefore arranged to illuminate the opening 4, in particular the sides of the aperture, so as to draw the customer's attention to the aperture.

A further light source 24, which is in the form of a fixed annular array of LEDs, is provided within the base 16 and below the platform 14 so as to direct illumination upwardly in the region of the platform, so that it passes through the apertures 14c in the platform and into the glass 20. These LEDs are therefore arranged to illuminate the glass 20 and beverage which it contains so as to draw the customer's attention to it.

The font 2 is mounted in use on a drinks bar 26 with the side 28 of the font on which the legs 8 are positioned being towards the customer. The font is therefore viewed in the direction of the arrow A by the customer so that the customer can see through the opening 4 in the arm 8 to the dispensing space. The opening therefore forms a window through which the glass, which is on the opposite side of the legs 8 and the window 4 to the customer, and anything of interest occurring therein can be readily viewed by the customer.

It can be seen that the height of opening 4 is commensurate with that of glass 20 which may in parts have a width commensurate in at least part with that of the opening.

Referring to FIGS. 2 and 3 in a second embodiment of the invention the opening 104 between the legs 108 is covered by a transparent covering 105 in the form of a magnifying lens. In this case it is a convex lens, but it could be in the form of a diffraction grating. The covering 105 therefore magnifies the glass 120 when it is under the dispense nozzle 110 and viewed by the customer through the opening 104. The magnifying lens may be arranged to magnify the substantially the whole of glass. Alternatively it may be arranged to magnify only a part of it. In a further variation the lens may be arranged simply to distort the view of the glass as seen by the customer so as to provide an interesting visual effect.

Referring to FIG. 4 in a further embodiment of the invention, the part 216a of the base 216 which defines the bottom of the aperture has a light source 207 and a screen 209 over the light source. A transparent covering 205 covers the aperture 204 and light from the light source 207 shines upwards through the screen 209 and onto the covering 205. The screen 209 comprises a number of liquid crystal elements which can be individually switched on and off by a control unit 211 in the base of the font. This allows messages or other images to be projected onto the covering 205 which will be visible to the customer as they look through the covering 205 at the glass 220.

The control unit 211 also controls the dispense of beverage in a beverage dispense cycle. The message or image is arranged to change during the dispense cycle. For example it can be arranged to start, stop or change at predetermined points in the dispense cycle, such as the beginning or end of the cycle. The message can be associated with the beverage being dispensed, for example including advertising material, or it may be purely for entertainment. The liquid crystal elements can be all of one colour, for example black, or they may be of various colours so that a coloured display can be produced.

The covering 205 is removably attached to the font so that it can be replaced by a different cover of a different colour or having a different pattern on it, for example so that it corresponds to the beverage that the font is set up to dispense.

In a modification to this embodiment the liquid crystal display is provided on the covering 205. This can then be controlled so as to produce messages or images on the covering as the beverage is being dispensed. In this case the light source can be omitted, or it can be directed at the beverage so as to improve its visibility through the covering 205.

Referring to FIG. 5, in a further embodiment of the invention the base 316 of the apparatus has a source 307 of ultra violet light which is arranged to shine onto the glass 320 when the glass is placed under the dispense nozzle 310. The glass has a patterned layer 313 of material on it which becomes luminescent under UV radiation. The pattern can therefore be seen through the covering 305 while the beverage is being dispensed. However, under normal light the pattern is not visible. An LCD screen similar to that in FIG. 4 could be used over the UV source so as to provide the pattern on the glass. In this case the glass would only need a uniform layer of the luminescent material. As a further alternative the UV light could be directed at the covering 305 which could have the covering of luminescent material on it.

We claim:

1. A font arranged to be mounted on a drinks bar counter to dispense draught beverage, the font comprising a base, a support arm extending upwards from the base and a head supported over the base by the support arm and including a dispensing nozzle for dispensing the beverage, the support arm and nozzle defining a dispense space in which a drinking vessel can be placed to receive beverage from the nozzle, wherein the support arm has a window through which a drinking vessel positioned in the dispense space can be viewed by a customer.

2. A font according to claim 1 wherein the support arm has an aperture therethrough which forms the window.

3. A font according to claim 1 wherein the support arm is positioned to one side of the dispense space, and the dispense space has a further side opposite to said one side which further side is open to allow the drinking vessel to be placed in and removed from the location.

4. A font according to claim 1 wherein the head is unsupported except for the support arm.

5. A font according to claim 4 wherein the arm is curved so that it arches over the dispense space.

6. A font according to claim 1 wherein the base includes a support arranged to support a drinking vessel in the dispense space.

7. A font according to claim 6 wherein the support is arranged to rotate the drinking vessel.

8. A font according to claim 7 wherein the support comprises a rotatable platform.

9. A font according to claim 8 further comprising drive means arrange to rotate the platform.

10. A font according to claim 9 wherein the drive means is arranged to rotate the platform during dispense of the beverage.

11. A font arranged to be mounted on a drinks bar counter to dispense draught beverage, the font comprising a base, a support structure extending upwards from the base and a head supported over the base by the support structure and including a dispensing nozzle for dispensing the beverage, the support structure and nozzle defining a dispense space in which a drinking vessel can be placed to receive beverage from the nozzle, wherein the support structure is a cantilever structure positioned to one side of the dispense space and has a window through which a drinking vessel positioned in the dispense space can be viewed by a customer.

12. A font according to claim 11 wherein the support structure comprises a pair of legs defining an aperture therebetween which forms the window.

13. A font according to claim 12 wherein the support structure is curved so that it arches over the dispense space.

14. A font arranged to be mounted on a drinks bar counter to dispense draught beverage, the font comprising a base, a pair of support legs extending upwards from the base and a head supported over the base by the support legs and including a dispensing nozzle for dispensing the beverage, the support legs and nozzle defining a dispense space in which a drinking vessel can be placed to receive beverage from the nozzle, wherein the support legs are both positioned to one side of the dispense space and define a window therebetween through which a drinking vessel positioned in the dispense space can be viewed by a customer.

15. A font as claimed in claim 1 further comprising transparent material arranged to at least partially form said window.

16. A font as claimed claim 1 further comprising at least one light source.

17. A font according to claim 16 wherein said at least one light source is arranged to direct light into said dispense space so that it will strike a drinking vessel placed in the dispense space.

18. A font according to claim 17 wherein the base includes a support arranged to support a drinking vessel in the dispense space, the support having at least one aperture therethrough, and said at least one light is arranged to direct light through said at least one aperture.

19. A font according to claim 15 wherein the transparent material is arranged to magnify at least a part of the vessel as seen by the customer.

20. A font according to claim 15 wherein the transparent material is arranged to distort at least a part of the vessel as seen by the customer.

21. A font according to claim 15 wherein the transparent material comprises an optical filter arranged to affect the colour of the vessel as seen by the customer.

22. A font according to claim 21 wherein the optical filter is controllable so as to vary its filter characteristics.

23. A font according to claim 21 wherein the transparent material is replaceable so as to vary the optical characteristics of the transparent material on the font.

24. A font according to claim 15 wherein the transparent material carries at least one of an image and a message.

25. A font according to claim 24 wherein said at least one of an image and a message is variable.

26. A font according to claim 25 wherein the font is arranged to dispense the beverage in a dispense cycle and said at least one of an image and a message is controlled so as to be varied at a predetermined point in the dispense cycle.

27. A font according to claim 17 further comprising a light source arranged to produce at least one of an image and a message on the vessel.

28. A font according to claim 27 wherein the light source is arranged to provide a pattern of light beams to produce said at least one of an image and a message.

29. A font according to claim 27 wherein the light source is arranged to produce light of a wavelength that will reveal said at least one of an image and a message on the vessel.

30. A font according to claim 29 wherein the wavelength is an ultra violet wavelength.
